(19) United States
(12) Patent Application Publication
(10) Pub. No.: US 2009/0157468 A1
(43) Pub. Date: Jun. 18, 2009

(54) INTERACTION-BASED METHOD FOR THE IMPLEMENTATION OF COORDINATION SYSTEMS

(76) Inventor: Antony K. Alappatt, Chennai (IN)

Correspondence Address: Pearl Cohen Zedek Latzer, LLP, 1500 Broadway, 12th Floor, New York, NY, 10036, US

(21) Appl. No.: 12/281,376

(22) PCT Filed: Mar. 1, 2006
(86) PCT No.: PCT/IN06/00070

§ 371 Date: Dec. 30, 2008

(51) Int. Cl. G06Q 10/00

(52) U.S. Cl. 705/9; 705/7

(57) ABSTRACT

The invention relates to a method for the designing, development and implementation of coordination system using an agent-based method. The method avoids the use of the conventional business function approach to design a business process.

### FIELD OF THE INVENTION

The present invention relates to a method for designing, developing and implementing coordination systems using an Interaction-based or Agent-based method.

### BACKGROUND OF THE INVENTION

Coordination systems sometimes referred to as Business Process Management Systems model how different people, automatons or organization interact to perform or facilitate an application or business process. Essentially the goal of a coordination system is to mimic and coordinate the actions that different organizations, people and machines would undertake to address tasks in that field. Coordination systems can be employed in a wide variety of settings.

To implement these coordination systems, the first action is often to map out the business process/workflow being addressed. Those activities that need to be automated are collected and documented. The documentation contains information to be collected, who should do what task and any decision flows to dispatch the right task to the right actor. To implement these coordination systems, currently a Software Development Life Cycle is followed. Business process is divided into multiple business functions. These business functions are designed and coded using any procedural programming language like JAVA, C, RPG, COBOL, BPML etc. The approach has limitations with respect to its extensibility and adaptability since changes to the business/application process activity could require significant changes to the original software code. This may introduce new errors into the code and cause inefficiency because the software code must be changed and recompiled.

### SUMMARY OF THE INVENTION

The object of the invention is to develop a coordination system by which people, business and agents interact to define a business process. By using this method a modular coordination system is developed where the business process can be expressed with minimal programming effort.

The present invention relates to a new “agent-based approach” and method of automating coordination systems. In this approach the business process is composed of business actions instead of functions. Under this approach no coding is necessary. Changes and extensions can be directly impacted, by manipulating actions. This will significantly improve productivity of business analysts as they can directly create applications, from output of business analysis.

### BRIEF DESCRIPTION OF THE DRAWINGS

FIG. (1) Flow diagram for the method of developing the coordination system

FIG. (2) illustrates a business process consisting of agents and actions

FIG. (3) illustrates a capability agent

FIG. (4) illustrates the sequence operator

FIG. (5.1) & FIG. (5.2) illustrates the replication operator

FIG. (6.1) & FIG. (6.2) illustrates the choice operator

FIG. (7) illustrates input-output panels of the UI agent

FIG. (8) depicts a reactor and its components

### DETAILED DESCRIPTION OF THE INVENTION

A coordination system allows people, machines and other organizations to interact with each other to create a business process. To implement the coordination system the first task is to map out the business process or workflow and identify (a) the tasks (b) decision flows (c) the capabilities of individuals to make decisions. Currently these coordination systems are implemented by following the software development life cycle. Business processes are divided into multiple business functions, which are designed and coded using procedural programming language.

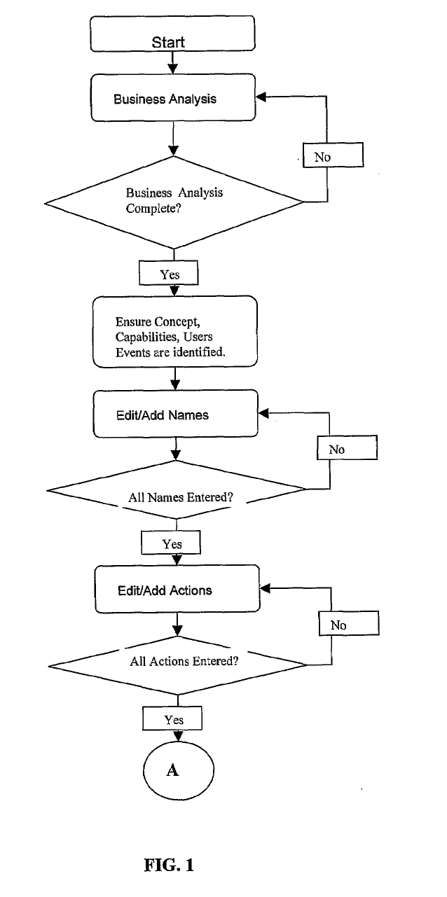

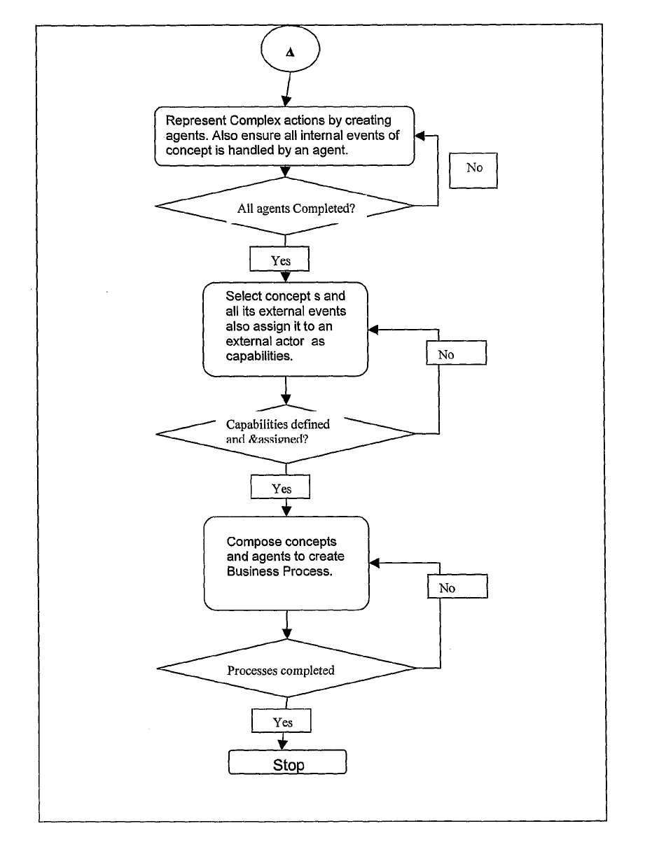

The present invention relates to an alternate method for developing and implementing these coordination systems. The method (FIG. 1) starts by analysing the business process to ensure that the various concepts, capabilities, users and events are identified. The next step is to create the events (actions) by assigning names to that. The next step is to attach actions to the concepts. All actions required are defined in the system and sets of complex actions are used to create an agent. The agent handles the internal events of the concept. The external events of the concept are assigned as capabilities to the users or the external actors. Various concepts, capabilities and agents thus identified and created are composed to form a business process.

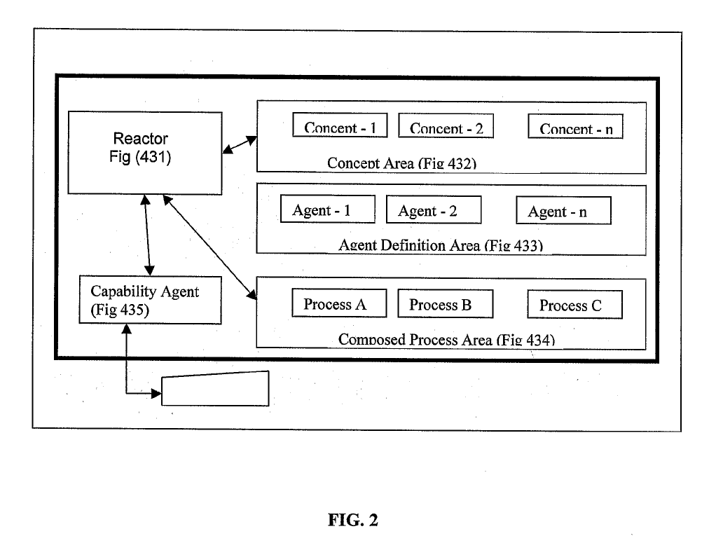

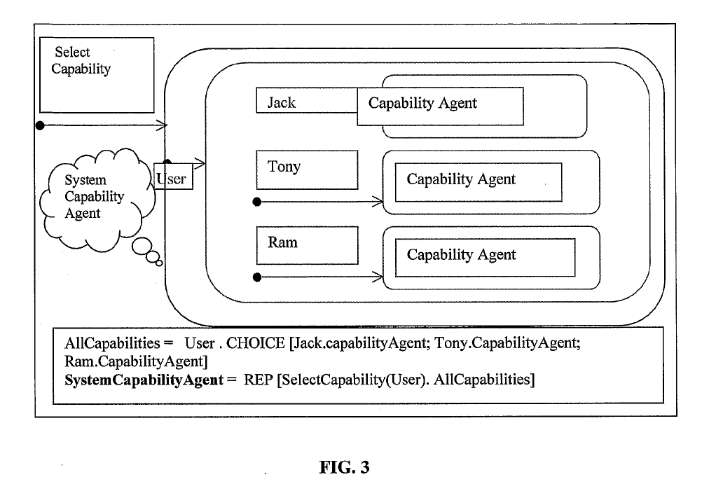

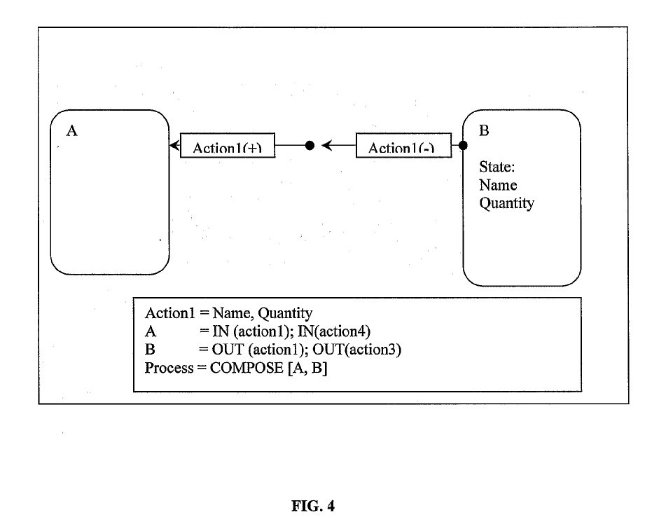

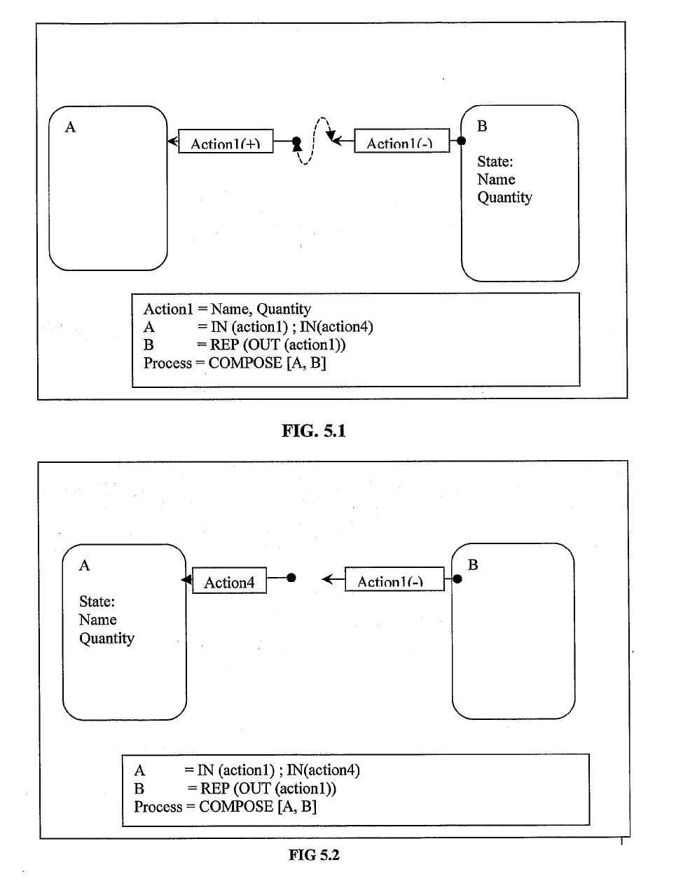

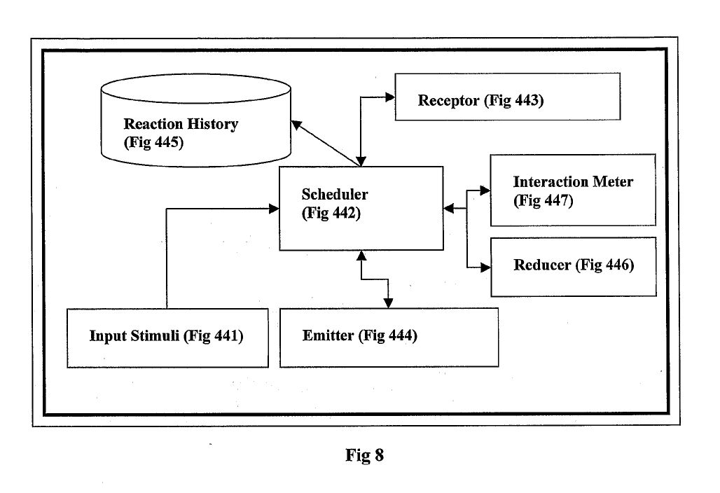

In the present invention an “Interaction-based” or “Agent-based” approach is used wherein the business process is implemented as shown in (FIG. 2) using a composition of actions instead of business functions. The process begins by identifying the key agents of the system, concepts, events and the capabilities and roles of these agents. Using these identified artifacts, a business process is defined. The system consists of a process repository, which holds the process definition. The reactor is the main component of a process. All actions of a process, its agents which are the definitions of the interaction capabilities of the process and its component processes are routed through the reactor where they are composed to create a business process. The reactor (FIG. 8) consists of the following components: (a) Receptor (b) Emitter (c) Input Stimuli (d) Interaction Meter (e) Scheduler (f) Reducer.

An emitter contains all actions for which the process is ready to produce output. The receptor contains all actions for which the process is ready to receive inputs. The action meant for a process is loaded into the process I/O stimuli. Each action that arrives in the I/O stimuli is passed to the scheduler, which then moves to the emitter or the receptor depending on the type of action required by the target. Each action arriving in the scheduler could be for composed process or for an agent. If the action is meant for a composed process, then the action is loaded to the input stimuli of that process. If the action is meant for an agent, then the agent script is appended to the process script and the first interactions for this agent are loaded to the reactor. The script thus created is kept in the process script area. The business process built this way can be billed “On Demand”. This feature is accomplished by the component Interaction Meter.

An action is the way the system communicates with other parts of the system. The action carries names between agents and processes. The action along with the complementary names represents the handshake between the different components i.e. the agents, the processes and the environment. The actions are of two types (a) positive (b) negative. A positive action represents the capability to commit an action and exhibits the capability to emit names. The negative action represents the capability to wait for a process and exhibits the willingness to accept names. When two complementary names (Positive and negative action with the same action name in the same process) come together then the two actions interact, this interaction is called a reaction. Each reaction can be notified to this Interaction Meter and charges can be billed to the end user on use.

The scheduler reads actions from the I/O stimuli. If the action is an output then it checks the receptor for availability of an action. If the action is found in the receptor then reaction history is loaded on to the log and the reduction activity starts or else the action is added to the emitter. The scheduler of a said process loads the data that came as the action into the process storage area. If the action is an input then it checks the emitter for availability of action and removes the said data from the process storage area. If during the input action, the action exists in the Emitter, then reaction history is loaded with names and reduction activity is also started.

A complex reduction activity happens in the reducer. Each input or output action leads to a change in the behavior of the process depending on the current state of the process script. The reducer treats each composed entity as a unit, which is a set of processes running in parallel. The unit that is affected due to the current action will be reduced. When a process starts up, the reducer divides the overall process into separate execution steps. These steps are kept in the reducer and the process is executed. The reducer sends the first command of each of these parallel steps to the I/O stimuli. The scheduler reads each of these actions and loads them into the receptor or the emitter depending on the type of action. During the loading process a complementary match could occur between the actions. Due to the complementary action match the reducer loads the next action for the affected units and all the units that have no further actions are discarded.

A UI agent acts as an interface between the user and the coordination system. The UI agent allows the user to create, modify or view the actions, agents and capabilities. The UI agent only receives input or output actions that are restricted with the help of the capability agent (FIG. 3), which contains all capabilities that are associated to a user. The UI agent provides four main features (a) Atomic agent support (b) Display user capabilities (c) Sequential actions cache (d) Show state of capability agent (e) Authentication. The UI agent helps validate the atomic agents like date, time, string etc. All capabilities that are associated to a user, is hidden behind the “Capabilities” action. The sequential actions cache maintains the order in which the actions are connected using the sequence operator, and all actions connected are shown in the UI agent as a wizard. The pending actions display keeps the state of all initiated actions. Authentication identifies the user, which is required to categorize the capabilities. The UI agent provides a “log on” screen to authenticate each user.

The capability agent keeps track of all the initiated actions. This can be received by listing all actions (other than the action “Capabilities”) with in the capability agent. The capability agent maintains the service catalog and pending actions. The service catalog is a collection of agents. Each represents how an action will be serviced. All these actions are composed to create the service catalog. The service catalog describes capabilities of a user. Each catalog is then assigned to users. The service catalog for a user can be accessed, by using the action “Capabilities”. Pending actions are those, which are not instantaneous. Some of the actions would be immediate and the other would be over long period of time. It is required to keep track of these actions when it is active. Once an action A is chosen, then all the other actions it triggers are kept behind guard.

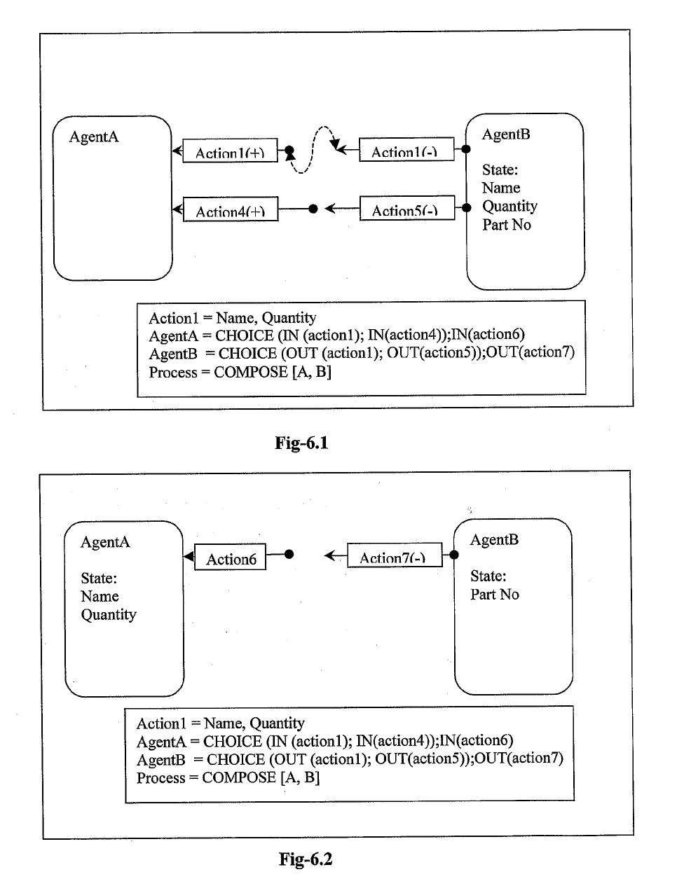

Any conception of the mind is a Concept. The concept manages state and also has sequences of action. The concept is the coordinator, which coordinates other agents to complete a process. The agents and their capable actions are used to create and manage concepts. Agents accept names and they produce one or more actions. The names have to be associated with a primitive agent. A names author is used to define the different names and their attachment to primitive agent. The input of the author is stored in a names repository. The agent has two components, one is the parameters/names accepted and the other is the agent complex. An agent complex is created, by composing actions and agents using the action or agent operators (a) compose (FIG. 2) (b) sequence (FIG. 4) (c) replication (FIG. 5.1 & FIG. 5.2) and (d) choice (FIG. 6.1 & FIG. 6.2). The IN and OUT are action operators. These action operators and the agent operators i.e compose, sequence, choice and replication are collectively called as process instruction. The agent complex should be expressive enough to specify complex response configurations. This complex response configuration is created by composing actions, agents and composing operators. Using these operators agents can be sequenced or grouped based on the concept to triggers multiple actions.

The concepts express the state of the agent, which unlike procedural process management does not require inspection of variables. Modularity is achieved in the system by the use of agents and each agent representing multiple actions. Thus by referring to a name, multiple actions can be referenced. Hierarchy is accomplished by using actions. The order of actions that will trigger other actions creates the hierarchy. The system also contains two reserved agents called the arithmetic agent and the decision agent to perform computations and decisions.

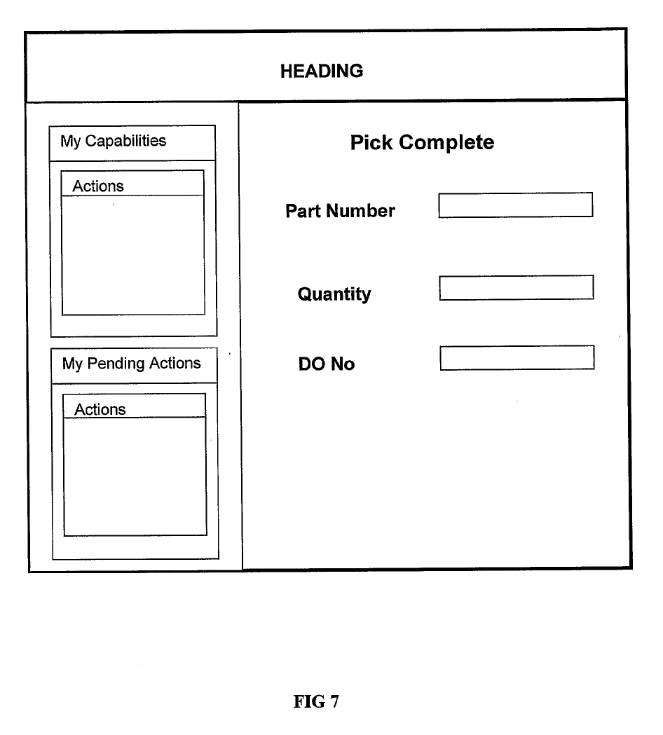

The business process is executed by creating various complex agents and concepts using the operators provided. Since the system comprises of multiple actions being performed at a given time, each action being an concretion (output) or an abstraction (input) the UI agent is designed to have two separate panels (FIG. 7) to display the input and output actions respectively.

The various aspects of the system are defined using different authors. The coordination layer is composed of the following authors (a). Names author (b) Actions or Business Event author (c) Agent author (d) Concept author (e) Business Process author (f) Team and Capability Agent author.

The names author is a screen, which lists all the names that are defined. The names have to be associated with a primitive name. The purpose of this author is to define the different names and their attachment to primitive agent. Primitive agents are agents that do not have any further interaction components. The screen provides two panels in which name can be added and a primitive agent can be associated with a name. The actions author is a screen, which lists all the actions that are defined. The purpose of the action is to carry names when two complementary actions react. The action author defines the different actions and the names they carry. The agent author is used to define an agent. The screen provides three panels, which can be used to give a name to an agent, the names communicated to the agent and composition of interactions. The concept author is used to define business rules. The concept author provides, screens where new concepts can be created. Besides naming concepts, the author shows all agents, actions/business events and operators to combine these agents and actions. It also shows how agents and actions are organized. The business process author in the system defines how the different agents in the system are composed to create the business process. This business process author converts the business process definitions into process instructions. The screen provides panels to select agents, operations, concepts and actions. The capability agent author defines capabilities. The team author defines different external parties (employees, organizations and automatons) to the system, who are part of the business process. The team author assigns capability to these external parties using the capability author. This author also shows all the concepts in the system.

The sequence of activities to be performed, by the coordination system are controlled by the concept. The concept triggers the different capabilities to perform actions. The internal and external events of the concept, triggers other concepts, agents and actors to carry out the business process. The external events are captured from the user using the UI agent. The internal events are those supported by the internal concepts and processes in the system. This method of designing a coordination system allows any change or enhancement of the business process by a mere addition of an agent and the complementary action or capability with the help of the UI interface.

The implementation of the present invention is illustrated with the help of a business process entitled Picking process. The picking process is a process that any warehouse personnel employ to pick product for shipping. The picking process begins when the warehouse receives a delivery order from the order management system. The warehouse system first accepts the delivery order, then it schedules the delivery for picking and then the picking is executed.

Each activity of the business process in can be programmed into a business function. The business process is created, by connecting multiple business functions through a data store (E.g. Relational Database, Flat files, Memory Pipes, IPC, etc). Programs can be written in a conventional procedural or high-level language to simulate these business functions to create a picking process. This has the disadvantage that when a function changes or sequencing of the business function changes then the coding have to be changed by use of an expert programmer who is familiar with such a system.

The present invention addresses these issues by taking an agent based approach. Rather than directly representing the functions as a set of programs, this invention represents each function as a configuration of actions. Complementary actions, communicate atomic names. Even getting input from an outside actor, is defined as action. The concept and actors with capabilities to do the action that is requested by the concept are brought together to create business process. The concept directs the action, and the capabilities associated with actors in the business execute the action. Since the invention only has to deal with how names are communicated, such a system can be easily used by business analysts to create a working business process.

To create any business system, the first step is to do a value analysis and document how the business process is defined. The invention recommends the use of the ‘applied Business Concepts design’ (aBCd™) method as suggested by Jacques Hale in his book. After the value analysis as per the (aBCd™) method, we arrive at the Concept diagram, Event Diagram and Team architecture diagram. From the documented Concept, Event and Team architecture the business process can be implemented directly using this invention.

For the sake of an example, let us take the picking process. The Concept is created using the Concept Author. Next to each of these events is given what parameters need to be communicated through these events and also what events needs to be recorded (for audit trail purposes).

To coordinate all agents in the picking process, concept that is identified is the “Pick Request Concept”. Next the different events (events are the same as actions in the system) the Concept supports, the names communicated when the event occurs and whether this event needs to be recorded are identified. The events are entered in the Action Author. The concept only establishes the rules of the Pick Request agent.

Each of these events generated by concept, by itself does not make the system work. Each of these concept events needs to be supported by a response to complete the process. These supporting elements and how they respond to these events are represented as agents. They can be entered into the system using the Agent Author. Some of the events are directly supported by agents in the system (Internal events) and others need support from a human being, another system or another organization (External Events). In the case of “Pick Request Agent”, the internal events are a) creation event called “Deliver”, b) “ScheduleByZone”, and c) “Scheduled”. The external Events are a) “PickReady”, b) “PickComplete”, and c) “Pick Partial”.

Each of the internal events identified earlier, needs to be responded by internal agents. The Agent author can be used to give expression to these events. The agent author is used to explain the different agents required for the concept “Pick Request Agent”.

Each of these external events is to be responded by an external actor. Not all external actors have all the capabilities. Depending on the skills of each actor or trust level, each actor functions in different capacities. I.e. the capabilities of an actor to respond or service the concept events are different among actors. Since the capabilities are different, all external actors interact with the concept or process through a capability agent. To define capability, each external event of a concept is given a name and a body. The body is used to define, how the user responds to this external event. The different capability agents are associated to different users, to give a behavior of a role-based business organization. By defining and attaching capabilities to different users, workflow is accomplished in a decentralized manner. There are two ways of creating a physical architecture. In one case the process engine (FIG. 2) can be in a single address space and other actors can connect to this machine. In another situation, we can make each process in different devices. As and when devices are composed, the capability of the overall system increases.

To explain how the capability agent, allows input for an External event the “Pick Ready” event is chosen. This event is tied to the capability agent “InitialPickReqAgent”. This “PickReady” link is shown to the user, if the concept event “PickReady” is raised. Once the user clicks on this capability, then the body of this capability agent will present two input Actions (“PickPartial” or “PickComplete” as they are part of the body of response for “PickReady”) to the UI agent, which would present actionable links in the UI. Once the user clicks one action, the screen is shown to accept all input from the UI for the selected action. Once the user of the UI confirms the action, both the actions are removed from the queue (accomplished by the scheduler in scheduler steps) and the selected action is synchronized with the Concept Event. This method is the same that is repeated for dealing with interactions, with people, automations and other organizations. Instead of the human if it is an automaton, then the medium of interaction would be Integration agent and not the UI agent. But all these interactions are mediated through the Capability Agent.

The business process is created, by composing all agents that handle the internal events. In this case all the agents are brought together to work concurrently. The medium of how the external events are handled depends on the medium selected by the external agent. If the external agent is coming through the human interface medium, then all requests are coming through the UI agent. If the medium selected by the external agent is a integration interface (like Web service), the actions are communicated through the Integration agent. The Business process automatically uses the capability agent and talks to the outside actors through either the UI or the integration agent. The business analyst, or whoever is defining the flow is protected from defining how the external events are connected to the External Actors.

For the business of picking to be effective, the agents that constitute the picking have also to be brought along with the capability agent. The interaction of the internal picking agents and the capability agent (which accepts the input from the outside) will finally complete the picking process. The following steps mention how these set of agents achieve the picking process.

Step-1: The picking process is initiated by triggering the “Deliver” action. On triggering the “Deliver” action, the names along with “Deliver” is transferred from the triggering process. In most cases this is the Order Management Process. During this triggering process the agent, PickRequestAgent is created.

Step-2: As per the concept “PickRequestAgent”, the next step is to output the action “ScheduleByZone”. The agent PickRequestAgent, blocks till synchronization is done on “ScheduleByZone” port. action. I.e the PickRequestAgent, waits till an “ScheduleByZone” input action appears.

Step-3: Only the agent “SchedulePickReqAgentByZone” can service this request by pickRequestAgent. So the “ScheduleByZone” output from PickRequestAgent is synchronized with “ScheduleByZone” action of “SchedulePickReqAgentByZone” agent.

Step-4: When the “ScheduleByZone” action binds, it triggers the action in the two agents of the picking process. The PickRequestAgent advances to “Scheduled” action and in “SchedulePickReqAgentByZone” it exposes the action “WarehouseZone”. This “WarehouseZone” guards against any reaction for PickRequestAgent, as the PickRequestAGent can move forward only after it is signaled “Scheduled” action (can only be provided “SchedulePickReqAgentByZone”).

Step-5: Meanwhile the capabilityAgent already exposes the, “WarehouseZone” port. This “WarehouseZone” port of capability agent and of “ScheduleByZone” bind. This binding of port, moves the “SchedulePickReqAgentByZone” forward, exposing “Scheduled” port. When complementary action (“Scheduled”) of PickRequestAgent and “SchedulePickReqAgenyByZone” react, the PickRequestAgent move forward to expose the “PickReady” action. (The point to remember here is that until a capabilityAgent with the action “WarehouseZone” arrives the pickrequest is blocked.)

Step-6: The Capability Agent also exposes the port “PickReady”. If a complementary “PickReady” port exist in Capability agent, then this is shown in the UI agent, for a human user to bind to this.

Step-7: The human user indicates his/her intention to bind to PickReady, by clicking on the “PickReady” link shown in the UI. If the user clicks on the “PickReady” link then, UI exposes the choice of “PickComplete” or “PickPartial” to the User Interface. The user makes a choice between “PickComplete” or “PickPartial” option.

Step-8: Depending on the choice taken by the user, one of the other options is removed. If the “PickComplete” option is chosen then the screen is shown, with all the input required for the “PickComplete” event. Depending on the type of inputs, the appropriate validation is done in the UI. For example, the different inputs for “PickComplete” are Part #, DO # and PickQty. We know Part # and DO # are strings and PickQty is a number. The UI agent makes sure that only number is entered for PickQty field.

Step-9: As per Step-8 the right numbers are entered and the Confirm action button is selected then all the values are communicated, through the selected port. In this case the port, “PickComplete” in PickRequestAgent is selected. Since the “PickComplete” port is bound then the “PickRequestAGent” moves forward, exposing the next action “Request Complete”.

It is to be recognized and understood that the invention is not to be limited to the exact embodiment as illustrated and described herein. For example, it should be apparent that the method according to the present invention can be used in a variety of applications with suitable modifications which is known to a person skilled in the art. Accordingly, all modifications readily attainable by one of ordinary skill in the art from the disclosure set froth herein are deemed to be within the spirit and scope of the present claims.

1. A method for the designing, development and implementation of coordination systems using an agent-based approach, the said method comprising the steps of analyzing the business; identifying the concepts, capabilities, users and events; creating or editing names; creating actions; defining agents by representing them using complex actions; assigning concepts to external actors as capabilities; and composing the said concepts and agents to create a business process.

2. A method as claimed in claim 1 wherein the agents interact using agent operators to create an abstraction or a concretion depending on the action sequence required.

3. A method as claimed in claim 1 wherein the agents and actions interact to create a concept, which can be communicated to other agents to complete a process.

4. A method as claimed in claim 1 wherein the agents and method are input in to the system with the help of a UI agent comprising of an atomic agent support, display user capabilities, sequential action cache and authentication.

5. A method as claimed in claim 1, wherein the software built can be billed “On Demand” using an interaction meter.

6. A method as claimed in claim 1, wherein the business process can be expressed with minimal programming effort.

7. A method of implementing a coordination system wherein the changes or enhancements, in business cycle can be expressed altering the agents and their capabilities.
